(19) United States
(12) Patent Application Publication
(10) Pub. No.: US 2025/0045832 A1
(43) Pub. Date: Feb. 6, 2025

(54) SYSTEM AND METHOD FOR CONNECTING INDIVIDUALS OFFERING AND SEEKING INVESTMENT OPPORTUNITIES

(71) Applicants: Joanna NELL, Arundel (AU); Glen TOWSE, Arundel (AU)

(72) Inventors: Joanna NELL, Arundel (AU); Glen TOWSE, Arundel (AU)

(21) Appl. No.: 18/708,465

(22) PCT Filed: Nov. 4, 2022
(86) PCT No.: PCT/AU2022/051326

§ 371 Date: May 8, 2024

(30) Foreign Application Priority Data
Nov. 8, 2021 (AU) 2021903557

(51) Int. Cl. G06Q 40/06

(52) U.S. Cl. CPC G06Q 40/06

(57) ABSTRACT

A connection is facilitated between a user having investment opportunities and potential investors to enable communication therebetween. Details from the user seeking to register their investment opportunity are received and recorded. The details include a description of the goods/services provided/to be provided by a business associated with the investment opportunity, thereby creating an investment opportunity profile. Information from each of the potential investors are received and recorded and based thereon, whether each of the potential investors meets one or more predefined criteria is verified, thereby confirming whether each potential investor has the necessary bona fides to represent their interest in an investment opportunity of the registered investment opportunities. A list of verified potential investor profiles are generated, and the investment opportunity profile of each user is compared with each verified potential investor profile to establish matches between investment opportunities of the investment opportunities and one of the potential investors.

### FIELD OF THE INVENTION

The present invention relates to a system and method for individuals seeking investment funds and investors seeking investment opportunities and facilitating connection therebetween with an increased level of confidence that the connection will be successful as compared with current methods.

### BACKGROUND OF THE INVENTION

Whether an individual is an entrepreneur, a startup or an established business owner, the ability to effectively raise capital can often mean the difference between success and failure. There are various methods for raising capital for a startup or business venture including, but not limited to, using personal funds, obtaining a business loan, crowd funding, relying on personal contacts, or relying upon external investors (for example, Angel Investors and Venture Capitalists).

Although the use of an individual's personal funds is the easiest means to raise capital for a startup or business venture, personally funding a business carries significant risk. Moreover, many individuals either do not have the funds required to adequately fund a business venture, or fail to accurately estimate the amount of funds required to adequately fund a business venture thereby increasing the risk of failure.

As an alternative to personally funding a business venture, many individuals elect to apply for a small business loan when deciding to launch a new business. However, there is no guarantee that a loan application will be approved with the applicant needing to establish that they meet specific requirements including adequate credit history and past business experience. Additionally, similar to personally funding a business venture, small business loans also carry significant risk.

Crowdfunding has recently been gaining increased attention as a capital raising strategy which involves raising small amounts of money from a large number of people. However, successful crowdfunding campaigns require a significant amount of time and effort and, only a fraction of crowdfunding campaigns meet their desired goals.

Another common method of raising capital for a business venture relies upon seeking a loan or investment funds from family members and friends. However, many individuals do not feel comfortable approaching family members and friends for money to fund a business venture. Moreover, such arrangements between family and friends often add more stress to the funding process and also carry significant risk, not only from a financial perspective, but from an emotional perspective. Accordingly, such arrangements are generally not advised.

Two types of external investors are Angel Investors and Venture Capitalists. Angel Investors are typically wealthy individuals who usually fund businesses alone, but sometimes join other Angel Investors to fund a business venture. In comparison, Venture Capitalists tend to invest in more mature companies as compared with Angel Investors, and tend to operate as a business representing many investors who have entrusted their funds to the Venture Capitalist. As compared with Angel Investors, Venture Capitalists tend to invest in fewer businesses, but when they do invest, tend to invest larger amounts of money. However, an issue with both Angel Investors and Venture Capitalists is the difficulty in establishing a connection with same, and hence, many individuals with an investment opportunity experience difficulty or discover that the process of raising capital from external investors is very time consuming and inefficient.

Currently there is no efficient means by which an individual with an investment opportunity is able to connect with a range of investors in a secure environment for both the individual with the investment opportunity and the investor. Accordingly, there exists a need for a system and method that addresses the above mentioned problems. In particular, there exists a need for a system and method that enables individuals to readily connect with a range of potential investors, in which security is afforded to the individual with a business opportunity regarding the bona fides of the potential investor(s) with potential investors having the details they require to quickly determine whether the investment opportunity is relevant to the type of opportunity they seek for the purpose of committing investment funds.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented system for facilitating connection between a user having one or more investment opportunities and one or more potential investors to enable communication therebetween, the system including, one or more processors operable to, receive and record details from the user seeking to register their investment opportunity, the details including at least a description of the goods and/or services provided, or that are to be provided, by a business associated with the investment opportunity, thereby creating an investment opportunity profile, receive and record information from each of the one or more potential investors, verify, based on at least the received information, whether each of the potential investors meets one or more predefined criteria thereby confirming whether each of the potential investors has the necessary bona fides to represent their interest in an investment opportunity of the one or more registered investment opportunities, generate a list of verified potential investor profiles, and compare, by the one or more processors, the investment opportunity profile of each user with each verified potential investor profile to establish matches between investment opportunities of the one or more investment opportunities and one or more potential investor of the one or more potential investors.

In an embodiment, the verification process regarding potential investors may include an estimate regarding a private wealth profile of the investor obtained from digital information regarding the investor according to any available data source that may be interrogated that is operably connected to the internet.

In an embodiment, users having investment opportunities may be required to meet a minimum standard of disclosure regarding the investment opportunity that is registered in the computer implemented system to generate an investment opportunity profile comprising various minimum requirements. Such minimum requirements may include an executive summary, overview of the market, revenue profile, expenditure, marketing estimates, personal profiles of the individuals operating the business and expected investment funds required to achieve objectives detailed in the executive summary.

In an embodiment, the computer implemented system may be operable to conduct a detailed analysis of investment opportunities such that various factors are identified including strengths, weaknesses, opportunities and threats according to a range of considerations such as barriers to market entry, investment requirements, estimated time to achieve return on investment, the quantum of return, the number of employees required, overview of business sector according to previous profits and geographical region, uniqueness of the investment opportunity, potential legal issues, estimated growth of investment and estimated return over pre-defined periods of time.

In an embodiment, the generated profiles of investment opportunities and potential investors may be supported by additional analysis of external data obtained from data sources accessible and operably connected to the internet.

In an embodiment, the interrogation of external data sources may utilise artificial intelligence techniques supported by character recognition techniques and scraping recognition technology to further support and verify profiles developed and recorded on the computer implemented system such that any identified matches between investment opportunities and investors provide both parties with a level of confidence according to verification with respect to the bona fides of all parties conducted by the computer implemented system.

In an embodiment, the verification process regarding potential investors utilises blockchain technology.

In an embodiment, the system may be operable to continuously review and analyse investment opportunities and investor profiles to identify and propose potential matches that achieve or exceed a pre-defined threshold match between investment opportunities and investors wherein the continuous and ongoing identification of matching investment opportunities and investors is conducted automatically.

In an embodiment, the computer implemented system by be further operable to enable individual potential investors to indicate their interest in joining other potential investors to form an investor consortium such that individual investors when joining a consortium may receive a greater number of possible investment matches beyond those identified according to the investor acting as a sole investor.

In another aspect, the present invention provides a computer-implemented method for facilitating a connection between a user having one or more investment opportunities and one or more potential investors to enable communication therebetween, the method including, receiving and recording, by one or more processors, details from the user seeking to register their investment opportunity, the details including at least a description of the goods and/or services provided, or that are to be provided, by a business associated with the investment opportunity, thereby creating an investment opportunity profile, receiving and recording, by the one or more processors, information from each of the one or more potential investors, verifying, by the one or more processors, based at least on the received information, whether each of the potential investors meets one or more predefined criteria thereby confirming whether each of the potential investors has the necessary bona fides to represent their interest in an investment opportunity of the one or more investment opportunities, generating, by the one or more processors, a list of verified potential investor profiles, and comparing the investment opportunity profile of each user with each verified potential investor profile thereby establishing a match between an investment opportunity of the one or more investment opportunities and a potential investor of the one or more potential investors.

In another aspect, the present invention provides a computer-readable medium having a plurality of stored executable instructions thereon that, when executed, cause one or more processors to perform the steps of, receiving and recording details from a user seeking to register their investment opportunity, the details including at least a description of the goods and/or services provided, or that are to be provided, by a business associated with the investment opportunity, thereby creating an investment opportunity profile, receiving and recording information from each of one or more potential investors, verifying, based at least on the received information, whether each of the potential investors meets one or more predefined criteria thereby confirming whether each of the potential investors has the necessary bona fides to represent their interest in an investment opportunity of the one or more investment opportunities, generating a list of verified potential investor profiles, and comparing the investment opportunity profile of each user with each verified potential investor profile thereby establishing a matches between investment opportunities of the one or more investment opportunities and potential investors of the one or more potential investors.

### BRIEF DESCRIPTION OF THE DRAWINGS

Embodiments of the invention will now be described in further detail with reference to the accompanying figures in which:

FIG. 1 provides an overview of a system according to an embodiment of the present invention showing, in particular, the interaction of various system components.

FIG. 2 illustrates an exemplary diagram associated with the server component of the system illustrated in FIG. 1.

FIG. 3 illustrates an exemplary diagram of the server component of FIG. 2 interrogated by external data sources for verification and analysis purposes.

FIG. 4 illustrates an exemplary flow diagram of a process that enables a user to download and install a software application, and subsequently access or register to use the software application, for interaction with the system illustrated in FIG. 1.

FIG. 5 illustrates an exemplary flow diagram of a process that enables a user to use the software application to register an investment opportunity.

FIG. 6 illustrates an exemplary flow diagram of a process that enables an investor to use the software application for interaction with the system illustrated in FIG. 1.

FIG. 7 illustrates an exemplary flow diagram of a process that enables the matching of investors to investment opportunities.

FIG. 8 illustrates an exemplary flow diagram of a process that enables the formation of a consortium of investors.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth in order to provide a thorough understanding of the present disclosure. It will be readily apparent, however, that the current disclosure may be practiced without limitation to the specific details. In other instances, some methods and structures have not been described in detail to avoid obscuring the present disclosure.

The present invention relates to a method for facilitating a connection between a user (30) having one or more investment opportunities and one or more potential investors (40) to enable communication therebetween. The system and method provide a platform that hosts a computer executable software application (70) wherein the application (70) is accessible by a plurality of registered users, including users (30) seeking to list their investment opportunities and investors (40) seeking to fund investment opportunities for compensation. In particular, the system may utilize a central server (20) in communication with data communication devices (60) associated the users (30) and investors (40).

It will be appreciated that general reference to investors (40) herein is intended to reference either one or a combination of investors 40A, 40B and 40C.

The central server (20) maintains one or more processors and/or databases for performing functions, including receiving and recording details from a user (30) seeking to register their investment opportunity, the details including at least a description of the goods and/or services provided, or that are to be provided, by a business associated with the investment opportunity, thereby creating an investment opportunity profile. The central server (20) subsequently receives and records information from each of the one or more potential investors (40), and verifies, based at least on the received information, whether each of the potential investors (40) meets one or more predefined criteria. This confirms whether each of the potential investors (40) has the necessary bona fides to represent their interest in the investment opportunity.

The investors (40) who satisfy the predefined criteria may then form part of a list of verified potential investor profiles eligible to appear in search results that are presented to users (20) seeking investment in relation to investment opportunities (90). The central server (20) may compare the investment opportunity profile of each user (30) with each verified potential investor profile in order establish matches between investment opportunities (90) and potential investors (40).

The person skilled in the art would appreciate that the platform provides a solution that enables users (30) such as inventors and others who have investment opportunities (e.g. inventions, property and other prospects) with investors (40) who have been verified as having the relevant bona fides to represent their interest in the investment opportunities. Once an investment opportunity (90) has been listed by a user (30), the user (30) may be presented with a list of potential investors (40), or a consortium (50) of investors (40), that match the profile associated with the investment opportunity (90). Once a potential investor (40) or consortium (50) is selected by the user (30), a connection (260) between the user (30) and the investor(s) (40) may be established. Similarly, the platform may allow for a list of available investment opportunities (90) to be presented to investors (40), to enable investors to connect and communicate with users (30).

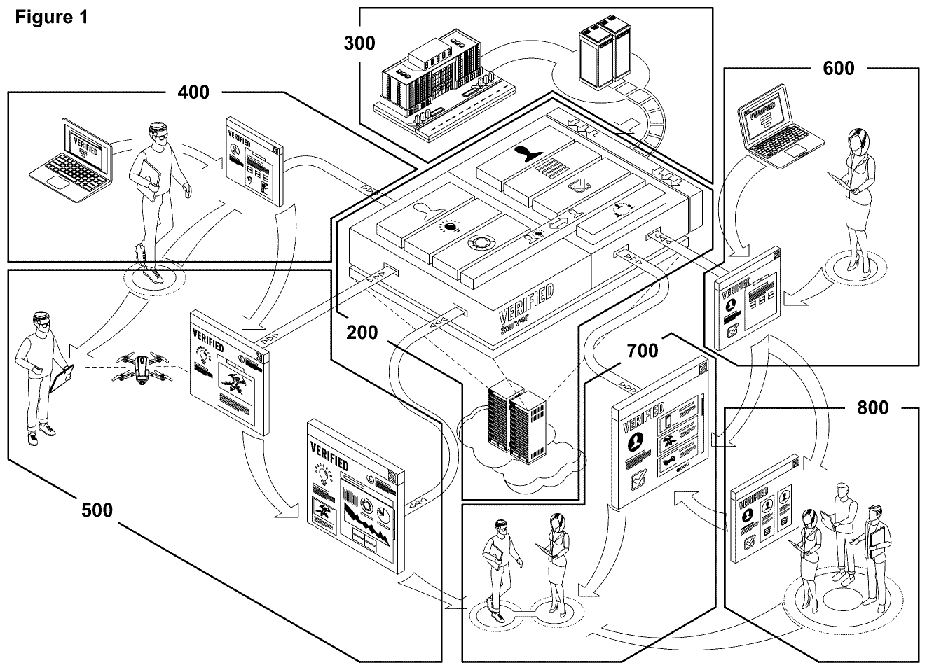

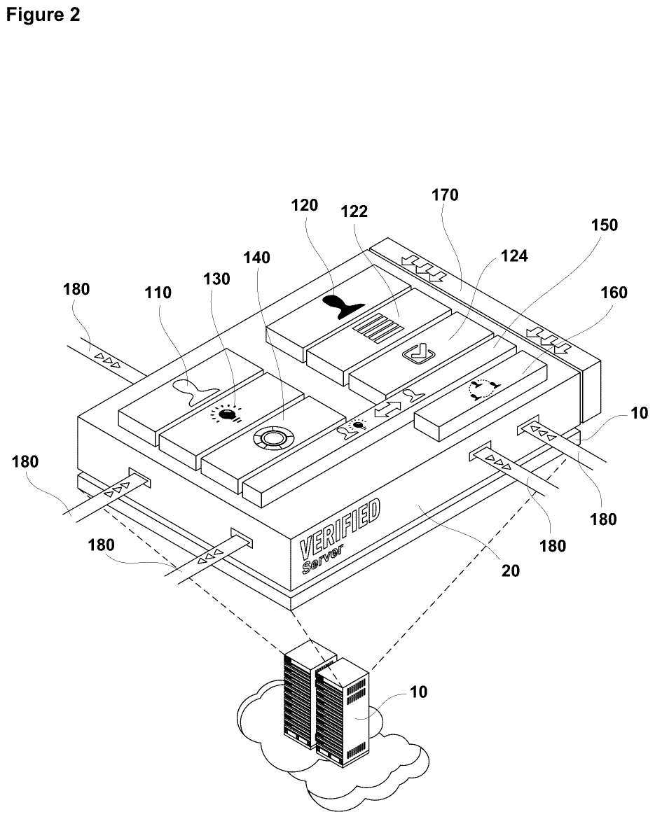

FIG. 1 is divided into segments which are further expanded in subsequent FIGS. 2 to 8. In particular, segment 200 of FIG. 1 shows the server component (20) with which the software application (70) operating on data communication devices (60) are configured to communicate. It will be apparent to the person skilled in the art that the software application (70) may be a mobile application or a web application and that, similarly, the data communication devices (60) utilised by the users (30) and investors (40) may be mobile devices or computer devices. The server component (20) is additionally detailed in FIG. 2, and the person skilled in the art will appreciate that the steps described herein, as executed by the devices (60), may be facilitated by the software application (70) operating on each device (60).

As an alternative, or in addition to, steps described herein as performed by the server (20), the steps described may be performed by one or more processors associated with the user devices (60). Different arrangements are possible in this regard, but according to a particular implementation of the present invention, the server (20) is programmed to provide all of the functions described herein where they cannot be provided locally on the user devices (60).

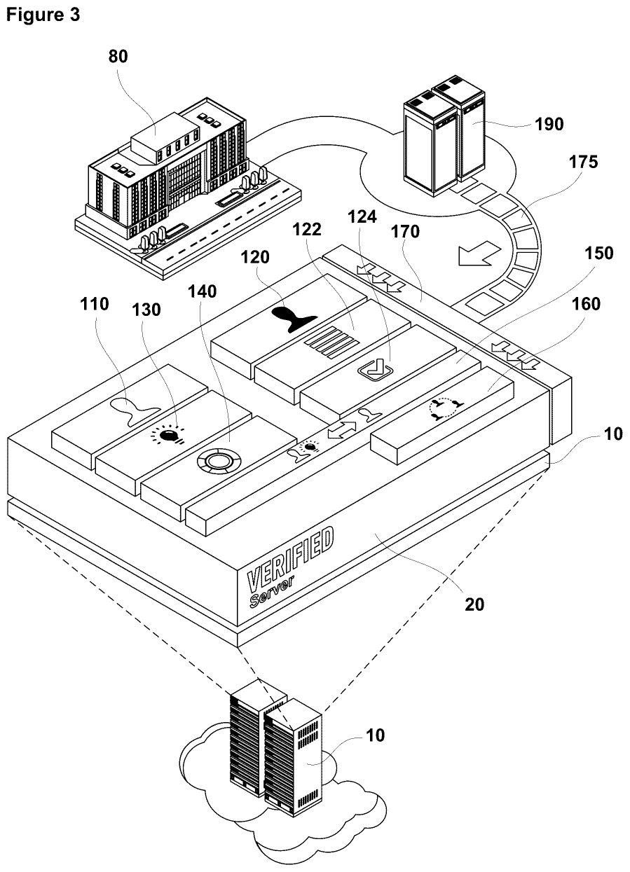

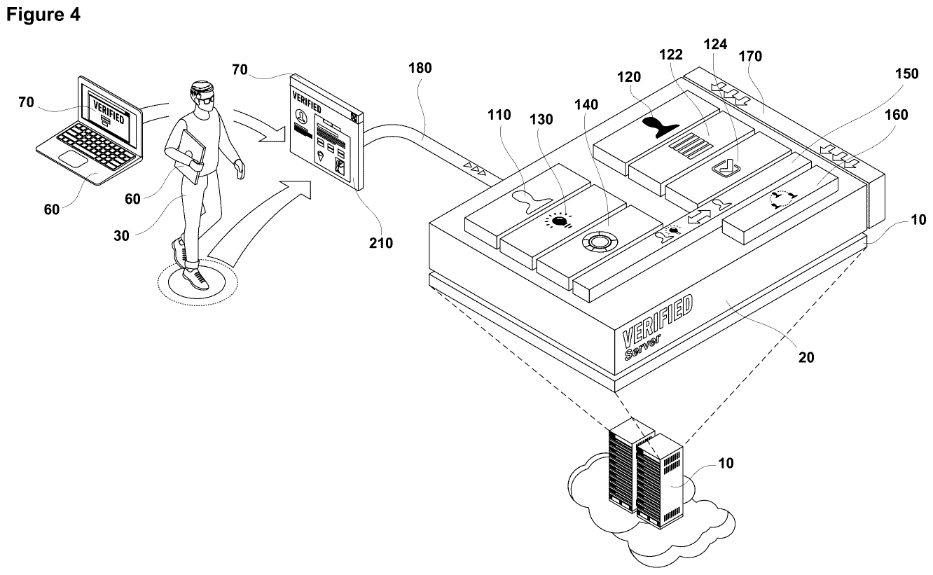

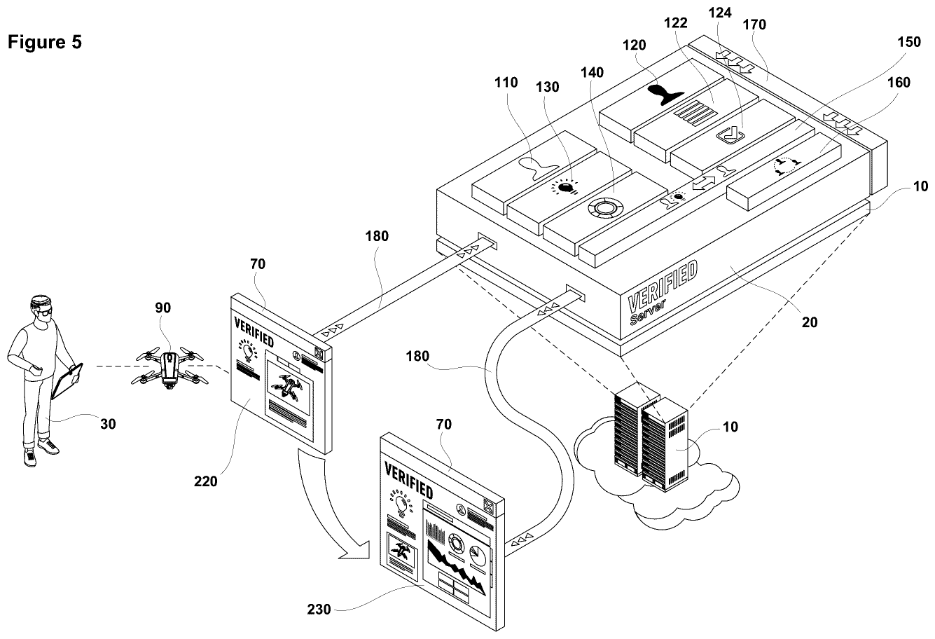

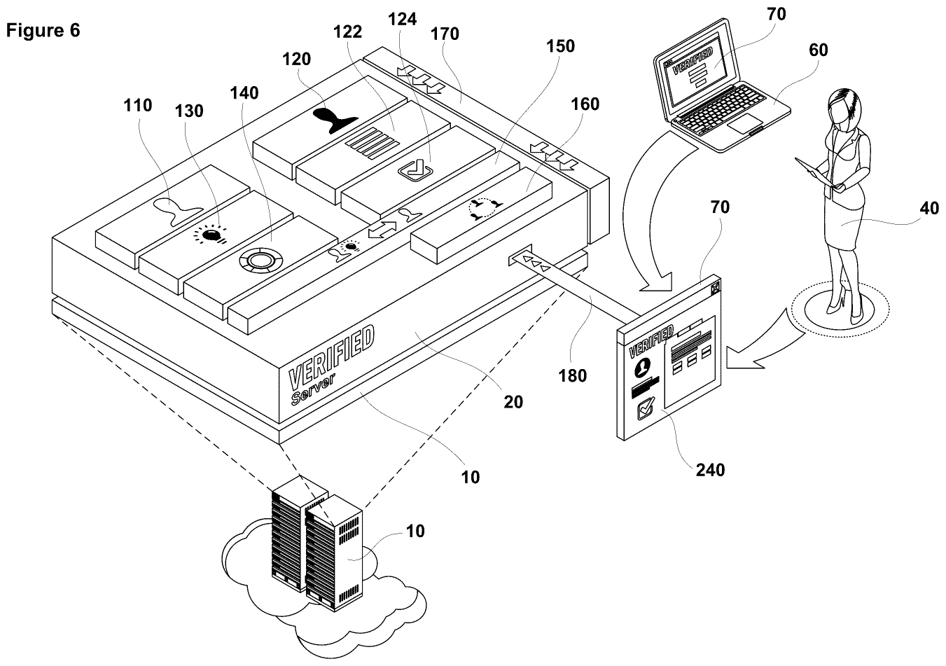

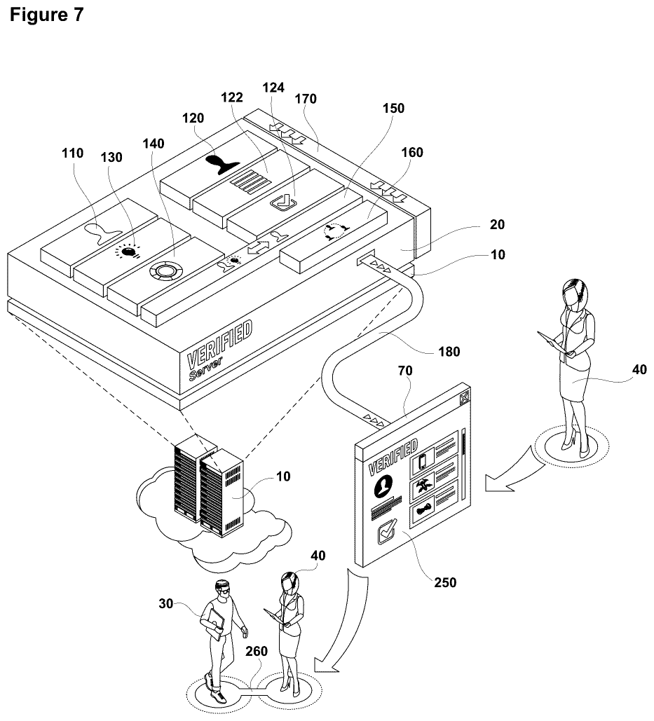

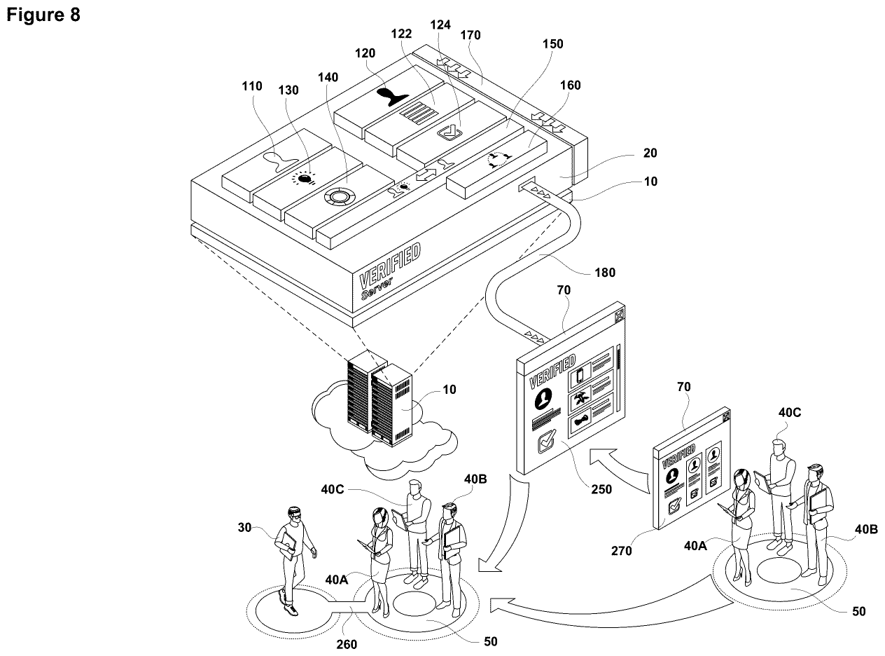

Segment 300 of FIG. 1 shows how the server (20) may be configured for interrogation by multiple external data sources (80) for the purpose of verification of users (30) and investors (40), as well as analysis of investment opportunities (90), as further detailed in FIG. 3. Segment 400 of FIG. 1 shows a user (30) downloading and installing the application (70) and subsequently accessing the application (70) in order to establish an account and investment opportunity profile(s), as further detailed in FIG. 4. Segment 500 of FIG. 1 illustrates how user (30) may list an investment opportunity (90) and enable an analysis of the opportunity to occur for the benefit of investors (40), which is further detailed in FIG. 5. Segment 600 of FIG. 1 illustrates how investors (40) can access the software application (70) and establish an investor profile, as detailed in FIG. 6. Segment 700 of FIG. 1 illustrates the matching of investors (40) to investment opportunities (90), as detailed in FIG. 7. Finally, segment 800 of FIG. 1 illustrates the formation of consortiums of investors (40), as detailed in FIG. 8.

As mentioned above, FIG. 2 shows in greater detail the segment 200 of FIG. 1 and in particular, FIG. 2 shows the server component (20) which includes infrastructure (10) upon which the platform of the present invention operates. The infrastructure (10) may be local or cloud-based. The central server (20) may operate one or more computer processors and maintain one or more databases to enable the following functionality and/or storage:
User account register 110 storing details of users (30) such as name, age, address, and contact details, and any additional data which may be relevant for the purpose of identifying each user (30). Where possible, these details will be verified using identification verification services;
Investor account register 120 storing details of investors (40) such as name, age, address, and contact details, and any additional data which may be relevant for the purpose of identifying each investor (40). Where possible, these details will be verified using identification verification services as described below with respect to feature 124;
Profile register 122 storing details relating to profiles established for users (30) in relation to their listed investment opportunities (90), and details relating to each investor's ability to invest in opportunities, along with investment preferences and areas of interest. Data stored in this register may be utilized for the purpose of determining a match between investors (40) and particular investment opportunities (90);
Verification register (124) storing the details and status of checks that have been performed on users (30) and investors (40) against, for example, one or more external databases (80). Data stored in this register may be utilized for the purpose of verifying the identification details of users and investors alike, and to ensure that each meet certain minimum criteria (e.g. ensuring that investors (40) have the bona fides to represent their interest in investment opportunities (90);
Investment opportunity register (130) storing details relating to investment opportunities that have been listed by users (30). Data stored in this register will need to meet a minimum standard of disclosure by each user (30) in relation to the investment opportunity (90), and will be utilized for the purpose of analysing the opportunities to ensure they are verified to a certain threshold and generating information for use by investors (40) to enable investors (40) to make informed investment decisions;
Analysis/Reporting engine (140) for generating information, reports and/or documents for presentation to investors (40) regarding particular investment opportunities (90) (e.g. detailed Information Memorandums (IMs), business plans, investment analysis reports, and similar documentation). The generation of this reporting information for investors (40) will be based upon data provided by users (30) in relation to their investment opportunities (90) along with additional data and information from external sources (80), as described in greater detail below;
Matching engine (150) responsible for comparing the investment opportunity profiles of each user with verified potential investor profiles to establish matches between investment opportunities (90) and potential investors (40). The matching engine (50) may rely upon the use of machine learning algorithms and the like to continuously review and analyse investment opportunities (90) and investors based on information in profile register (122) to identify and propose potential matches;
Investor consortium register (160) storing details relating to consortiums (50) of investors, i.e. a register of investors (40) who have formed consortiums (50); and
External data store (170) which may be used store data that has been collected from external data sources (80) and used for verification and opportunity analysis purposes.

FIG. 2 also depicts that server (20) is configured to enable communication (180) with the user/investor devices (60) and, in particular, the software applications (70) operating on each device (60), and FIGS. 2 and 3 show how communication (175) may be established with computer systems (190) associated with the external sources of data 80, such communications occurring via the internet or similar network.

FIG. 4 shows in greater detail segment 400 of FIG. 1 and, in particular, the steps associated with a user (30) accessing a user login and registration interface 210 associated with the application (70). Such access will be granted after the user (30) has installed the application (70), which may be achieved by downloading the application (70) from an application store. Each user (30) may create an account using the application 70 and the account information may be stored in the account register (110), and as described above, the user account register (110) may capture information sufficient to enable each user (30) to be correctly identified.

Once the application (70) has been accessed by a user (30), the user (30) may be presented with an interface identical or similar to interface (210) to allow the user (30) to create and maintain a user profile, including providing the user (30) with the ability to add/edit details and access all functionality of the application including to list investment opportunities (90) as well as to search for and view details relating to investors (40). Upon uploading sufficient information, each user (30) will be successfully registered such that the user (30) becomes a registered user who may then utilise the application's functionality.

An investor (40) seeking to download, install and register to use the application (70) would proceed through similar steps as those described above with respect to user (30). Similarly, the investor (40) may be presented with one or more interfaces (240) allowing the investor (40) to create and maintain a profile as well as to search for and view details relating to investment opportunities (90), as shown in FIG. 6 which shows in greater detail area 600 of FIG. 1. In this regard, an investor profile should capture sufficient information to demonstrate that the investor (40) is a legitimate investor having the ability to invest funds with respect to opportunities, and may further include investor preferences and areas of interest. The details submitted by investors (40) may be verified against information from the external data sources (80) to ensure they have the bona fides to represent their interest in investment opportunities (example data sources may include financial institutions, social media business accounts, private wealth profiles, and the like). Investors (40) may further be categorized into different categories or levels according to their preferences and other factors, e.g. by the amount of money they are prepared to invest, the type of funding they are prepared to provide (e.g. loan and/or equity financing), their particular qualifications and areas of interest, their preparedness to form part of a consortium of investors, etc. The categorization of investors (40) in this way will also make it easier for users (30) to search for investors (40) and filter their search results by category.

As mentioned above, FIG. 5 shows in greater detail area 500 of FIG. 1, and in particular, the use of the application (70) by a user (30) to establish a user profile and create an investment opportunity listing (220). In the example shown, the particular investment opportunity (90) relates to a novel way to control a drone. However, it is to be understood that the opportunity need not be limited to new “inventions”, and could extend to other opportunities including in relation to “property”, “new business ventures”, and any prospect for which investment funds are required (e.g. to develop a concept into a commercial offering). Once the listing has been completed, a profile relating to the particular investment opportunity is created as shown in interface (230), and this profile is viewable to investors (40) and may include one or more links to information sought by investors (40).

Similar to the requirement for investors (40) to provide sufficient information to enable their verification as legitimate investors, users (30) may also be required to submit sufficient information about themselves to verify their identity, etc (e.g. against external data sources (80) for the purpose of conducting checks such as employment checks, police checks and the like), and to satisfy investors that they are of sufficient standing and are sufficiently serious about their proposed investment opportunity. Indeed, before information and documents such as IMs, business plans and the like can be generated by the system for presentation to investors (40), a minimum amount of information must be submitted by each user (30) in relation to their investment opportunity (90). In other words, there will be a minimum standard of disclosure relating to new investment opportunity listings (220) submitted by users (30), and this submitted information will be used to create the documents and other information that are presented to potential investors to consider and decide whether they are interested in funding the investment opportunity.

Different users (30) may also be categorized into different categories or levels according to the details submitted by the users (30), including in relation to their background, the type of investment opportunity listed by the user, the amount of startup funding they have secured to date, the success or otherwise of previously listed investment opportunities, the type of funding sought (e.g. loan and/or equity financing), etc. This categorization of users (30) will also make it easier for investors (40) to search for users (30) and filter search results by user category.

It should now be apparent that the platform utilizes the data provided by users (30) when registering (220) their investment opportunities (90), along with any additional relevant data and information from external sources (80), to verify users (30) and investors (40) and to also generate detailed information for presentation to potential investors (40) in relation to the investment opportunities, including IMs and investment analytics.

In one example, the Information Memorandum may include an executive summary, overview of the market, proposed products and/or services, revenue profile, expenditure, marketing estimates, and funds required. The analysis of the investment opportunities (90) conducted by analysis/reporting engine (140) would typically take into account various factors including strengths, weaknesses, opportunities and threats. The analysis may also include a range of other considerations such as barriers to market entry, investment required, estimated time to achieve return on investment, employees required, overview of investment sector according to previous profits and geographical region, uniqueness of the investment opportunity, potential legal issues, estimated growth of investment, and return over pre-defined periods of time.

The interrogation of external data sources (80) may utilise artificial intelligence techniques supported by character recognition techniques and scraping recognition technology to further support and verify profiles developed and recorded using the platform such that any identified matches between investment opportunities (90) and investors (40) provide both parties with a level of confidence according to verification with respect to the bona fides of all parties.

When reviewing and analysing investment opportunities and investor profiles to identify and propose potential matches, a pre-defined similarity threshold may be used such that a match is achieved when the similarity between an investor and opportunity achieve or exceed the pre-defined threshold.

FIG. 7 shows in greater detail area 700 of FIG. 1 and, in particular, the automatic matching of investors (40) to investment opportunities (90) based upon a continuous analysis of newly posted/edited investment opportunities (90) and investor profiles. When an investor (40) and a posted investment opportunity (90) are automatically matched, each of the selected investor (40) and user (30) who listed the opportunity (90) may be immediately notified, e.g. by push notification, text, or email. The interface (250) in FIG. 7 represents an example interface that could be presented to at least the investor (40) confirming the automatic match with an investment opportunity (90) (in this example, the opportunity relating to the drone concept posted by user (30). This interface (250) may display or include one or more links to relevant information that the investor (40) may prefer to view prior to accepting the match and connecting (260) with the user (30), e.g. an Information Memorandum, business plan or investment analysis relating to the investment opportunity (90). Of course, the investor (40) may elect to conduct additional due diligence associated with user (30) and/or the investment opportunity (90) prior to finally agreeing to pursue the investment opportunity (90) and connect with the user (30).

It will be appreciated that investors (40) may have the option to search through a listing of investment opportunities or users who have posted investment opportunities, and may even filter through search results according to user category or the like. However, the automatic matching of investors with investment opportunities and the automatic provision of matched opportunities to investors without the need to prompt investors to conduct searches for opportunities, represents a process that assists investors in becoming aware of (and acting upon) opportunities more quickly and efficiently. Moreover, the results of automatic matching are likely to be more accurate and hence more likely to result in the securing of investment in respect of investment opportunities (90), as compared with the results of a manual search conducted by an investor (40) for example. Further, computer processing, network and memory resources that would otherwise have been consumed during the process of investors searching for opportunities will be conserved. These represent technical problems that are addressed by the implementation of the system and method described herein.

In circumstances where an investor (40) is interested in pursuing an investment opportunity (90), the platform may facilitate the connection (260) of the user (30) with the investor (40) or consortium (50), as also shown in FIG. 7.

FIG. 8 shows in greater detail area 800 of FIG. 1 and, in particular, the ability for a group of investors 40A, 40B and 40C to join a consortium (50) of investors, for the purpose of jointly funding an investment opportunity (90) associated with a user (30). A consortium could automatically be suggested in circumstances where multiple investors have been automatically matched to a particular investment opportunity (90). In other words, an interface (270) may be generated and presented to investors (40), the interface (270) displaying a listing of additional investors to whom a similar notification has been sent, and the interface (270) may allow the multiple recipients to agree to join with the other recipients. In this regard, a time limit could be placed upon the particular opportunity that is the subject of interface (270), wherein investors (40) must agree to join the consortium within a predetermined period of time after receiving the notification.

In another embodiment, only those investors (40) who have similar attributes, e.g. a similar area of interest, will be invited to join a particular consortium (50). Investors (40) may also be given the opportunity to select whether or not they are prepared to be part of a consortium at all, and any investor (40) who prefers not to be offered an invitation to join a consortium (50), will be automatically excluded from this option. It should also be understood that consortiums (50) may be formed pre-emptively, i.e. prior to any matching or posting of investment opportunities. In this way, once a consortium (50) is formed, all members of the consortium (50) may receive additional matches based upon the group of investors (40) collectively having attributes that meet the requirements of the investment opportunity, e.g. based on the group collectively having more investment funds.

As used herein, the term “central server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented system for facilitating connection between a user having one or more investment opportunities and one or more potential investors to enable communication therebetween, the system comprising:
one or more processors operable to:
receive and record details from the user seeking to register their investment opportunity, the details comprising at least a description of the goods and/or services provided, or that are to be provided, by a business associated with the investment opportunity, thereby creating an investment opportunity profile;
receive and record information from each of the one or more potential investors;
verify, based at least on the received information, whether each of the potential investors meets one or more predefined criteria thereby confirming whether each of the potential investors has the necessary bona fides to represent their interest in an investment opportunity of the one or more registered investment opportunities;
generate a list of verified potential investor profiles; and
compare, by the one or more processors, the investment opportunity profile of each user with each verified potential investor profile to establish matches between investment opportunities of the one or more investment opportunities and one or more potential investors of the one or more potential investors, the one or more processors operable to continuously review and analyse investment opportunities and investor profiles to identify and propose potential matches that achieve, or exceed, a pre-defined threshold match between investment opportunities and investors wherein the continuous and ongoing identification of matching investment opportunities and investors is conducted automatically.

2. The computer-implemented system according to claim 1, wherein the verification process regarding potential investors comprises interrogation of one or more external data sources operably connected to the internet.

3. The computer-implemented system according to claim 1, wherein the verification process regarding potential investors utilises blockchain technology.

4. The computer-implemented system according to claim 1, wherein the verification process regarding potential investors comprises obtaining an estimate regarding a private wealth profile of the investor obtained from digital information regarding the investor.

5. The computer-implemented system according to claim 1, wherein the user having an investment opportunity is required to meet a minimum standard of disclosure regarding the investment opportunity that is registered in the computer implemented system to generate an investment opportunity profile having minimum requirements comprising any one or more of an executive summary, an overview of the market, revenue profile, expenditure, marketing estimates, personal profiles of the individuals operating the business and expected investment funds required to achieve objectives detailed in the executive summary.

6. The computer-implemented system according to claim 1, wherein the one or more processors are operable to conduct a detailed analysis of investment opportunities to identify one or more factors comprising strengths, weaknesses, opportunities and threats according to a range of considerations comprising any one or more of barriers to market entry, investment requirements, estimated time to achieve return on investment, the quantum of return, the number of employees required, overview of business sector according to previous profits and geographical region, uniqueness of the investment opportunity, potential legal issues, estimated growth of investment and estimated return over pre-defined periods of time.

7. The computer-implemented system according to claim 1, wherein the generated profiles of investment opportunities and potential investors is supported by additional analysis of external data obtained from data sources accessible and operably connected to the internet.

8. The computer-implemented system according to claim 2, wherein the interrogation of external data sources utilises one or more artificial intelligence techniques to further support and verify the potential investor profiles developed and recorded on the computer-implemented system.

9. The computer implemented system according to claim 8, wherein the one or more artificial intelligence techniques comprise character recognition techniques and scraping recognition technology.

10. The computer-implemented system according to claim 1, wherein the one or more processors are further operable to enable individual potential investors to indicate their interest in joining other potential investors to form an investor consortium such that individual investors, upon joining a consortium, receive a greater number of possible investment matches beyond those identified according to the investor acting as a sole investor.

11. A computer-implemented method for facilitating a connection between a user having one or more investment opportunities and one or more potential investors to enable communication therebetween, the method comprising:
receiving and recording, by one or more processors, details from the user seeking to register their investment opportunity, the details comprising at least a description of the goods and/or services provided, or that are to be provided, by a business associated with the investment opportunity, thereby creating an investment opportunity profile;
receiving and recording, by the one or more processors, information from each of the one or more potential investors;
verifying, by the one or more processors, based at least on the received information, whether each of the potential investors meets one or more predefined criteria thereby confirming whether each of the potential investors has the necessary bona fides to represent their interest in an investment opportunity of the one or more investment opportunities;
generating, by the one or more processors, a list of verified potential investor profiles; and
comparing the investment opportunity profile of each user with each verified potential investor profile thereby establishing a match between an investment opportunity of the one or more investment opportunities and a potential investor of the one or more potential investors, further comprising continuously reviewing and analysing investment opportunities and investor profiles, by the one or more processors, to identify and propose potential matches that achieve or exceed a pre-defined threshold match between investment opportunities and investors wherein the continuous and ongoing identification of matching investment opportunities and investors is conducted automatically.

12. The computer-implemented method according to claim 11, wherein the verification process regarding potential investors comprises interrogation of one or more external data sources operably connected to the internet.

13. The computer-implemented method according to claim 11, wherein the verification process regarding potential investors utilises blockchain technology.

14. The computer-implemented method according to claim 11, wherein the verification process regarding potential investors comprises obtaining an estimate regarding a private wealth profile of the investor obtained from digital information regarding the investor.

15. The computer-implemented method according to claim 11, wherein the user, having an investment opportunity, is required to meet a minimum standard of disclosure regarding the investment opportunity that is registered in the computer implemented system to generate an investment opportunity profile having various minimum requirements comprising any one or more of an executive summary, an overview of the market, revenue profile, expenditure, marketing estimates, personal profiles of the individuals operating the business and expected investment funds required to achieve objectives detailed in the executive summary.

16. The computer-implemented method according to claim 11, further comprising conducting, by the one or more processors, a detailed analysis of investment opportunities to identify one or more factors comprising strengths, weaknesses, opportunities and threats according to a range of considerations comprising any one or more of barriers to market entry, investment requirements, estimated time to achieve return on investment, the quantum of return, the number of employees required, overview of business sector according to previous profits and geographical region, uniqueness of the investment opportunity, potential legal issues, estimated growth of investment and estimated return over pre-defined periods of time.

17. The computer-implemented method according to claim 11, wherein the generated profiles of investment opportunities and potential investors is supported by additional analysis of external data obtained from data sources accessible and operably connected to the internet.

18. The computer-implemented method according to claim 11, wherein the interrogation of external data sources utilises one or more artificial intelligence techniques to further support and verify the potential investor profiles developed and recorded on the computer implemented system.

19. The computer implemented method according to claim 18, wherein the one or more artificial intelligence techniques comprise character recognition techniques and scraping recognition technology.

20. The computer-implemented method according to claim 11, further comprising enabling, by the one or more processors, individual potential investors to indicate their interest in joining other potential investors to form an investor consortium such that individual investors, upon joining a consortium, receive a greater number of possible investment matches beyond those identified according to the investor acting as a sole investor.

21. A computer-readable medium having a plurality of stored executable instructions thereon that, when executed, cause one or more processors to perform the steps of:
receiving and recording details from a user seeking to register their investment opportunity, the details comprising at least a description of the goods and/or services provided, or that are to be provided, by a business associated with the investment opportunity, thereby creating an investment opportunity profile;
receiving and recording information from each of one or more potential investors;
verifying, based at least on the received information, whether each of the potential investors meets one or more predefined criteria thereby confirming whether each of the potential investors has the necessary bona fides to represent their interest in an investment opportunity of the one or more investment opportunities;
generating a list of verified potential investor profiles; and
comparing the investment opportunity profile of each user with each verified potential investor profile thereby establishing matches between investment opportunities of the one or more investment opportunities and potential investors of the one or more potential investors, further comprising continuously reviewing and analysing investment opportunities and investor profiles, by the one or more processors, to identify and propose potential matches that achieve or exceed a pre-defined threshold match between investment opportunities and investors wherein the continuous and ongoing identification of matching investment opportunities and investors is conducted automatically.
